(19) United States
(12) Patent Application Publication
(10) Pub. No.: US 2004/0085575 A1
(43) Pub. Date: May 6, 2004

(54) Print system and printer

(75) Inventor: Takeaki Hashimoto, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/693,895

(22) Filed: Oct. 28, 2003

(30) Foreign Application Priority Data
Oct. 28, 2002 (JP) 2002-312597

(51) Int. Cl. B41J 1/00

(52) U.S. Cl. 358/1.15

(57) ABSTRACT

It is an object of the present invention to provide a print system and a printer which enable a user to identity the printer having produced a print on the basis of this print without impairing the quality of the print. A host section transmits print data to a plurality of printers to instruct them to carry out printing. Each printer carries out printing as instructed by the host section. Prints from each printer are discharged to a particular area. Various printers discharge prints to the particular area. However, each print is provided with mark dots at a position that varies with the printers. Accordingly, examining the print enables a user to identify the printer having produced this print. A gradation value for the mark dots is determined taking a gradation value for surrounding dots into account.

### BACKGROUND OF THE INVENTION

1. Field of the Invention

The present invention relates to a print system and a printer which print print data.

2. Description of the Related Art

Printers have been known which print documents, figures, and tables. In recent years, printers or print systems have been popularized which enable the printing of images photographed using a digital camera or created using a personal computer.

For example, as printers that enable images photographed using a digital camera to be printed on print paper, what is called “TA printers” are commercially available which employ a TA (Thermo Autochrome) method for printing. With the TA method, a thermal head is used to heat color print paper (hereinafter referred to as “TA paper”) having a C, M, and Y color developing layers, at a predetermined temperature to develop a color that tends to be developed at this temperature. Then, the paper is irradiated with ultraviolet rays with a predetermined wavelength using a fluorescent lamp or the like to fix the developed color. This method is thus characterized by eliminating the need for ink or toner.

Furthermore, sublimation type thermal transfer printers are popular which heat an ink ribbon to sublimate and attach ink already applied to the ribbon, to exclusive paper coated with a resin.

Moreover, conventional ink jet type printers may be used to print images photographed using a digital camera.

Recently, digital cameras have been provided with mass recording media so that a large number of images can be saved in the recording medium. In these circumstances, print machines are on the market which use TA printers, sublimation type thermal transfer printers, or ink jet type printers such as those described previously. In these print machines, a plurality of these printers are connected together or mounted in order to print color images at a high speed. An over-the-counter print system is an example.

It is assumed that prints produced by a print system in which a plurality of printers are connected together or mounted are discharged from, for example, a discharge port formed in only one area of the print system. Then, if any print discharged from the discharge port is defective, it is necessary to determine which printer has produced this print. The word “defective” means that the colors in the print are too light or dark or that the print is striped. These defects result from a decrease in pressure exerted on paper caused by the wear of the head or the degradation of carriage rubber.

To identify the printer that has caused a defect, it is contemplated that prints may be subjected to a certain process so as to allow the user to identify the printer on the basis of information obtained in association with the process.

To process prints, the prints may be stamped with marks as described in Japanese Patent Application Publication No. 5-92865, which has objects and system configurations different from those of the present invention. However, when prints are stamped with marks, the commercial values of the prints themselves may be impaired if the user can visually identify the marks easily and if the prints need to have high quality as in the case with photographs or the like.

### SUMMARY OF THE INVENTION

It is an object of the present invention to provide a print system and a printer which enable a user to identity the printer having produced a print on the basis of this print without impairing the quality of the print.

According to a first aspect of the invention, there is provided a print system comprising:

a plurality of printers each having information identifying the printer,

a host section that transmits print data to the plurality of printers to instruct the printers to carry out printing,

a discharge portion to which prints from each printer are discharged,

a printer particular information providing device with which during printing, the printer provides, on each print to be discharged from the discharge portion, particular information indicating which printer has produced the print.

According to the first aspect of the present invention, the host section transmits print data to the plurality of printers to instruct them to carry out printing. Then, each printer carries out printing as instructed and discharges prints to the discharge portion. Prints from various printers are discharged to the discharge portion. However, each print is provided with the particular information indicating which printer has printed this print. Therefore, examining the print enables the user to identify the printer having produced this print.

A second aspect of the present invention is the print system according to the first aspect, wherein each of the printers determines a position at which the particular information is to be provided, from the size of the print data transmitted to the printer.

According to the second aspect of the present invention, the position at which the particular information is to be provided is determined from the size of the print data transmitted to each printer. Consequently, the particular information provided position is determined in accordance with the print data size.

A third aspect of the present invention is the print system according to the second lo aspect, wherein the particular information is a printed indication on printed surface of the print, and the printer analyzes print data present around the determined particular information provided position and provides, on the basis of results of the analysis, an indication which is less noticeable than the print data present around the determined particular information provided position but which can still be visually discovered.

According to the third aspect of the present invention, the printer analyzes the print data present around the determined particular information provided position and provides, on the basis of the results of the analysis, the indication which is less noticeable than the print data present around the determined particular information provided position but which can still be visually discovered.

A fourth aspect of the present invention is the print system according to the second aspect, wherein the position at which the particular information is provided varies with the printers, and each printer determines a position at which the particular information is to be provided on the basis of the information identifying the printer.

According to the fourth aspect of the present invention, the position at which the particular information is provided varies with the printers.

According to a fifth aspect of the present invention, there is provided a printer comprising:

an analyzing device analyzing print data, and

an indication providing device which provides an indication which is unnoticeable but can still be visually discovered, on a print to be produced, on the basis of results of the analysis.

According to the fifth aspect of the present invention, the indication which is unnoticeable but can still be visually discovered is provided on the print to be produced, on the basis of the results of the analysis.

According to the first aspect of the present invention, examining prints discharged to the discharge portion enables the user to determine the printers having produced these prints. Accordingly, if any print has a defective part or the like, the user can promptly discover the printer having produced this print. Therefore, the user can promptly and accurately find and eliminate the cause of the defect.

According to the second aspect of the present invention, the particular information provided position is determined in accordance with the print data size. This eliminates the need to search for the particular information regarding the print data size.

According to the third aspect of the present invention, the print indication is provided which is less noticeable than the data present around the printed indication but which can still be visually discovered. Accordingly, the printed indication itself cannot be discovered without examining the print consciously. This prevents the quality of prints themselves from being degraded but still allows the user to discover easily the printed indication by examining the prints consciously.

According to the fourth aspect of the present invention, the position at which the particular information is provided varies with the printers. Accordingly, the same type of information can be provided at different positions. This facilitates the discovery of the particular information. Therefore, the printers can use the same structure for providing the particular information.

According to the fifth aspect of the present invention, the indication is provided on the print which is unnoticeable but which can still be visually discovered. Accordingly, the display itself cannot be discovered without examining the print consciously. This prevents the quality of prints themselves from being degraded but still allows the user to discover easily the display by examining the prints consciously.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a front sectional view of an over-the-counter digital photo print system to which a print system according to the present invention is applied;

FIG. 2 is a block diagram showing the configuration of hardware in a print machine;

FIG. 3 is a block diagram showing arrangements relating to a print process executed by each printer using the TA method;

FIG. 4 is a sectional view showing the configuration of TA paper;

FIG. 5 is a layout drawing showing an embodiment of the arrangement of members of a print processing section of each printer which section executes print processes including the development and fixation of colors on TA paper;

FIG. 6 is a diagram showing an area of a print in which mark dots are provided;

FIG. 7 is an enlarged diagram of a part B in FIG. 6, showing mark dots and dots for mark gradation value; and

FIG. 8 is a diagram showing the relationship between the gradation value of the mark dots and a gradation value corresponding to an average value for surrounding mark gradation value reference dots.

### DETAILED DESCRIPTION OF THE PREFERRED EMBODIMENTS

With reference to the accompanying drawings, description will be given of a preferred embodiment of a print system according to the present invention.

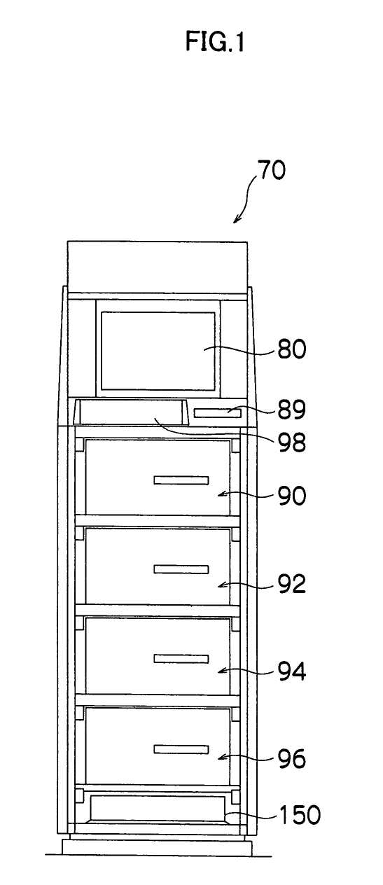

FIG. 1 is a front sectional view of an over-the-counter digital photo print system to which the print system according to the present invention has been applied. This over-the-counter digital photo print system is a print machine with TA printers that employ a TA method. With the TA method, a user inserts a recording medium such as Smart Media into a media insertion slot 89 and then loads money into the system to print digital images stored in the recording medium, on TA paper.

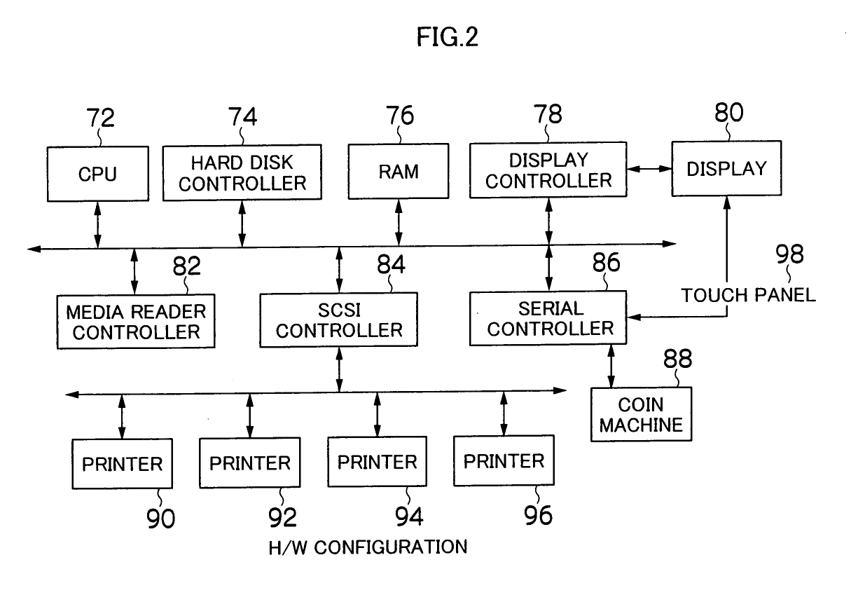

This print machine 70 has a touch panel 98 disposed on its front surface and a liquid crystal display 80 disposed at the top of the front surface. While viewing the display 80, the user operates the touch panel 98 to input required information such as a print size or the number of prints. Printers 90, 92, 94, and 96 are installed inside the print machine 70 in its middle and lower areas. Each of the printers 90 to 96 can print digital images. Accordingly, with the print machine 70 according to the present embodiment, the four printers can print images. An output port 150 is formed at the bottom of the outside front surface so that printed TA paper of a size specified by the used can be discharged through the output port 150. A coin machine (shown at 88 in FIG. 2) is mounted in this area.

FIG. 2 is a block diagram showing the configuration of hardware in the print machine 70.

The user inserts a recording medium into the media insertion port 89 (FIG. 1). A hard disk controller 74 operates control software recorded in a hard disk (not shown). Image data is recorded in the recording medium after being compressed into a predetermined format. A CPU 72 instructs a media reader controller 82 to read the image data to acquire required image data from the recording media. The CPU 72 then expands the image data to restore it to the original. The CPU 72 further subjects the data to a required image process to store the processed data in a RAM 76.

Through the touch panel 98, the user inputs the required information such as the print size or the number of prints. The inputted information is displayed on the display 80 and transmitted to a serial controller 86. The display 80 is operated by a display controller 78. The coin machine 88 checks whether the user has loaded the amount of money displayed on the display, on the basis of the information inputted through the touch panel 98. If the required amount of money has been loaded, the image data stored in the RAM 76 is transmitted to the printers 90, 92, 94, and 96 via a SCSI controller 84 as a print job. These processes are controlled by the CPU 27.

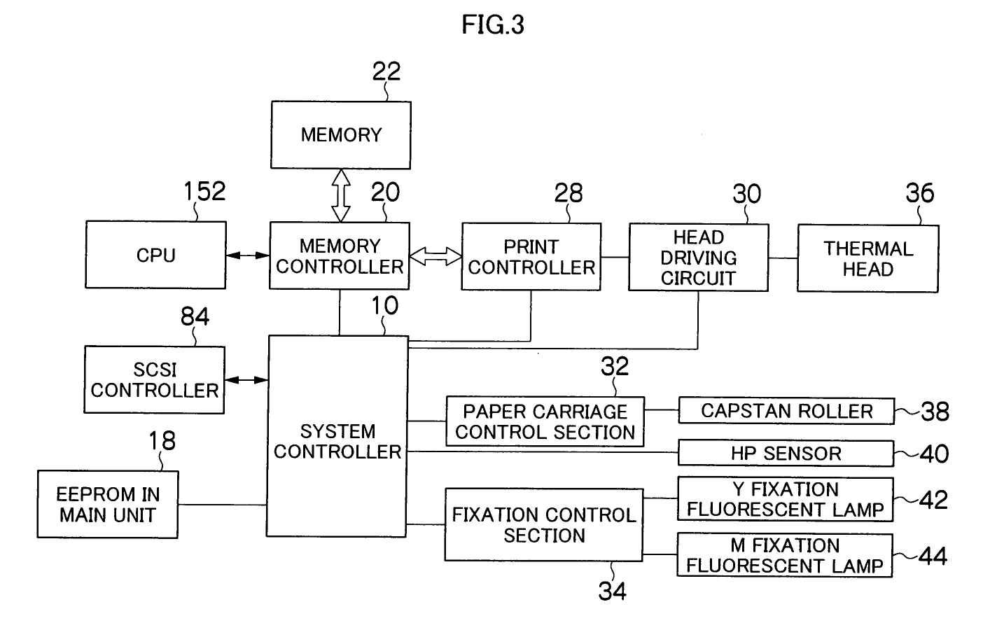

The printers 90 to 96 employs a print method called the “TA method”. This method uses TA paper which develops a color when heated and which fixes the color when irradiated with light of a predetermined wavelength. Description will be given of arrangements and operations relating to a print process executed by each printer using the TA method. FIG. 3 is a block diagram showing the arrangements relating to the print process executed by each printer using the TA method.

As shown in FIG. 3, a system controller 10 is a processing section that integrally controls the whole system. The system controller 10 is connected to the SCSI controller 84 in the print machine 70. The system controller 10 receives jobs from the SCSI controller 84. The system controller 10 is adapted to deliver image data to each control block and give the control block various instructions on the execution of printing and the like. The CPU 72 gives the system controller 10 instructions on various processes on the basis of the touch panel 98, operated by the user. Operation programs for the system controller 10 are recorded in an EEPROM 18.

A job delivered by the SCSI controller 84 is stored in a memory 22 via the system controller 10 and a memory controller 20. Specifically, the memory controller 20 is a processing section that controls data writes to and reads from the memory 22. The memory controller 20 operates to store image data such as print images in the memory 22, the print images being received from the SCSI controller 84 and system controller 10. In accordance with an instruction from the system controller 10, the image data such as print images stored in the memory 22 is outputted to a print controller 28. The memory 22 stores the ID number of a unique SCSI of the printer. That is, each of the printers 90, 92, 94, and 96 stores the ID number of the SCSI unique to the printer.

The print controller 28, a head driving circuit 30, a paper carriage control section 32, and a fixation control section 34, all of which are shown in FIG. 3, are control blocks used to execute printing. These control blocks synchronously perform various control operations in accordance with an instruction on the execution of printing which instruction is given by the system controller 10.

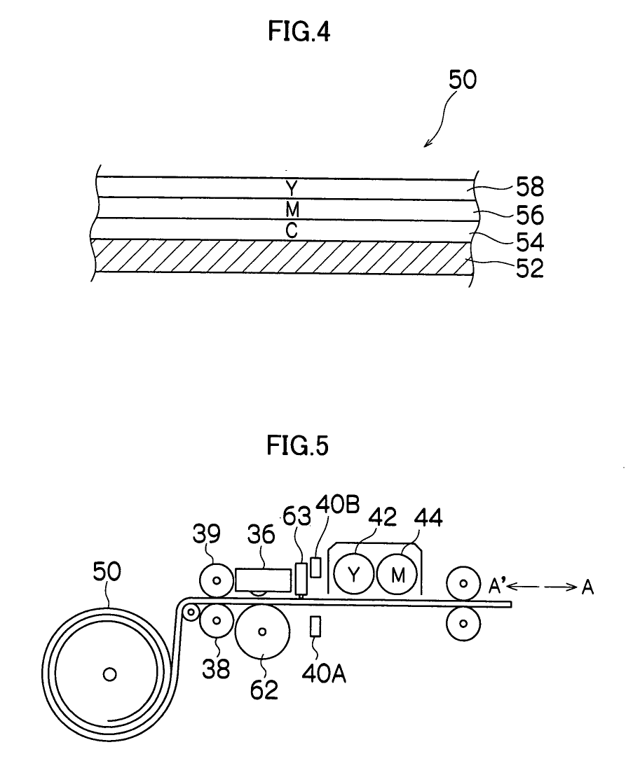

Then, description will be given of TA paper used in this printer. As shown in FIG. 4, TA paper 50 is formed of three layers sequentially stacked on a surface of a support 52, the three layers including a cyan (C) color developing layer 54, a magenta (M) color developing layer 56, and a yellow (Y) color developing layer 58. When the C color developing layer 54, the M color developing layer 56, and the Y color developing layer 58 are subjected to corresponding quantities of heat, a C, M, and Y colors of densities (gradation) corresponding to the quantities of heat are developed. Furthermore, when the color developing layers other than the C color developing layer 54, i.e. the M color developing layer 56 and the Y color developing layer 58 are irradiated with light of corresponding wavelengths (about 365 nm for the M color developing layer 56 and about 425 nm for the M color developing layer 58), the developed colors are fixed.

Upon receiving an instruction on the execution of printing from the system controller 10, the print controller 28 acquires image data on the print image stored in the memory 22 by the memory controller 20. On the basis of the image data on the print image, the print controller 28 then sets gradations (print gradation values) for the C, M, and Y colors in each pixel of the print image within the range of, for example, an 8-bit resolution (0 to 255). The print controller 28 then outputs data on the print gradation values for the C, M, and Y colors in each pixel of the print image to the head driving circuit 30 synchronously with the traveling of TA paper line by line in a direction (main scanning direction) perpendicular to the traveling direction (sub-scanning direction).

At this time, a CPU 152 calculates data required to generate a mark dot with an optimum gradation value in an area of the TA paper specified in connection with the storage of the ID number of the SCSI unique to the printer in the memory 22, the mark dot being generated from image data present around the specified area. The system controller 10 then outputs the data to the control blocks via the memory controller 20, the control blocks including the print controller 28, the head driving circuit 30, the paper carriage control section 32, and the fixation control section 34.

Upon receiving the data on the print gradation values for the C, M, and Y colors from the print controller 28 as described above, the head driving circuit 30 controls voltages applied to dot-by-dot heating elements in a thermal head 38 arranged in the main scanning direction as well as the time (pulse width) required to energize the heating elements; this control is carried out synchronously with the traveling of the TA paper, on the basis of the print gradation values. This allows the quantity of heat provided to each point of the TA paper by the corresponding dot-by-dot heating element in the thermal head 36 to be controlled in accordance with the print gradation values for the C, M, and Y colors. Thus, in the color developing layers of the TA paper, the respective colors are developed which have densities corresponding to the print gradation values specified by the print controller 28.

Upon receiving an instruction on the execution of printing from the system controller 10, the paper carriage control section 32 feeds TA paper from a TA paper housing section to a TA paper print processing section. The TA paper housing section has a roll of TA paper 50 loaded in it. Furthermore, after feeding the TA paper to the print processing section, the paper carriage control section 32 uses a motor to drive a capstan roller 38 to drive the TA paper synchronously with print processes including color development and fixation. At this time, the system controller 10 uses a home position (HP) sensor 40 to detect that the TA paper is located at its home position. The system controller 10 then causes the paper carriage control section 32 to reciprocate the TA paper using the home position as a reference.

The fixation control section 34 controls the lighting and extinction of a Y fixing fluorescent lamp 42 and an M fixing fluorescent lamp 44 synchronously with the process executed by the thermal head 36 to develop the colors of the Y and M light developing layers in the TA paper. The Y fixing fluorescent lamp 42 has a light emission characteristic indicated by a peak wavelength of at least 425 nm. When the Y fixing fluorescent lamp 42 is lighted to irradiate the TA paper with light with the above wavelength, the Y color developing layer in the TA paper is fixed. On the other hand, the M fixing fluorescent lamp 44 has a light emission characteristic indicated by a peak wavelength of at least 365 nm. When the M fixing fluorescent lamp 44 is lighted to irradiate the TA paper with light with the above wavelength, the M color developing layer in the TA paper is fixed.

FIG. 5 is a layout drawing showing an embodiment of the arrangement of the members of the print processing section of each of the printers 90 to 96, which section executes print processes including the development and fixation of the colors on the TA paper.

As shown in FIG. 5, the print processing section has the following components sequentially arranged on a carriage path along which the TA paper 50 is fed: the capstan roller 38, a nip roller 39, the thermal head 36, a platen roller 62, a cutter 63, a light emitting LED 40A and a light receiving sensor 40B constituting an HP sensor 40, a Y fixing fluorescent lamp 42, and an M fixing fluorescent lamp 44.

The TA paper 50 fed from the upstream side of the carriage path is sandwiched between the capstan roller 38 and the nip roller 39 and also between the thermal head 36 and the platen roller 62. During a print process, the capstan roller 38 is rotatively moved by the motor to reciprocate the TA paper 50 in the sub-scanning direction, shown by arrows A and A′.

The thermal head 36 has a plurality of heating elements arranged in a line in the main scanning direction, which is perpendicular to the sub-scanning direction, in which the TA paper 50 is carried. The heating elements provide heat to the TA paper 50 line by line in the main scanning direction synchronously with the carriage of the TA paper 50 in the printing direction shown by the arrow A in the figure. This causes the color developing layers to develop the respective colors.

The LED 40A of the HP sensor 40 floodlights the light receiving sensor 40B across the carriage path for the TA paper 50. The HP sensor 40 can detect the presence of the TA paper 50 on the basis of a detection signal from the light receiving sensor 40B. A detection signal outputted by the light receiving sensor 40B is inputted via an A/D converter (not shown) to the system controller 10, shown in FIG. 3.

The system controller 10 carries out detection as to whether or not light provided by the LED 40A is received by the light receiving sensor 40B, to determine whether or not the TA paper 50 is located at the position of the HP sensor 40. Then, the system controller 10 detects the switching between the period when the leading end of the TA paper is located at the position of the HP sensor 40 and the period when the leading end of the TA paper is not located at the position of the HP sensor 40, to carry out detection as to whether or not the leading end of the TA paper 50 has been carried to the position of the HP sensor 40. Thus, the TA paper is aligned using, as the home position of the TA paper 50, the point in time when the leading end of the TA paper 50 reaches the position of the HP sensor 40. This position is used as a reference to synchronize the carriage of the TA paper 50 with the print processes including the development and fixation of the colors.

Description will be given of a mechanism that generates mark dots in a predetermined area in the TA paper 50, in the printers 90 to 96, configured as described above.

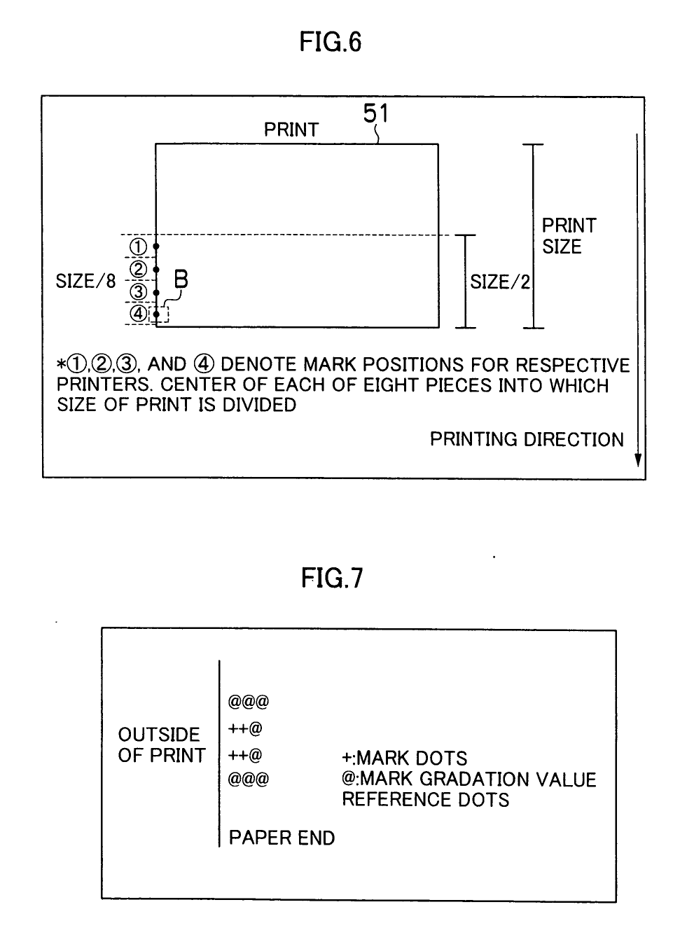

Since the memory 22 stores the ID number of the SCSI unique to the printer, mark dots are provided in a specified area corresponding to the ID number. The mark dots are provided in one area on the left side of a print 51 (having a size specified by the user and into which the TA paper is cut), specifically in the center of one of the eight pieces into which the size of the left side of the print is divided in the printing direction. In the present embodiment, since the four printers are provided, the mark dots are provided in the lower four divisions on the left side as shown in FIG. 6. The printer is determined depending on which division contains the mark dots.

FIG. 7 is an enlarged diagram of a part B in FIG. 6, showing mark dots and dots for mark gradation values. That is, this figure is an enlarged view of the above described area containing the mark dots. Two dots are provided in the printing direction, while three dots are provided in the direction orthogonal to the printing direction. Thus, in total, six dots are provided. The dots present around the mark dots are reference dots used to determine a gradation value for the mark dots.

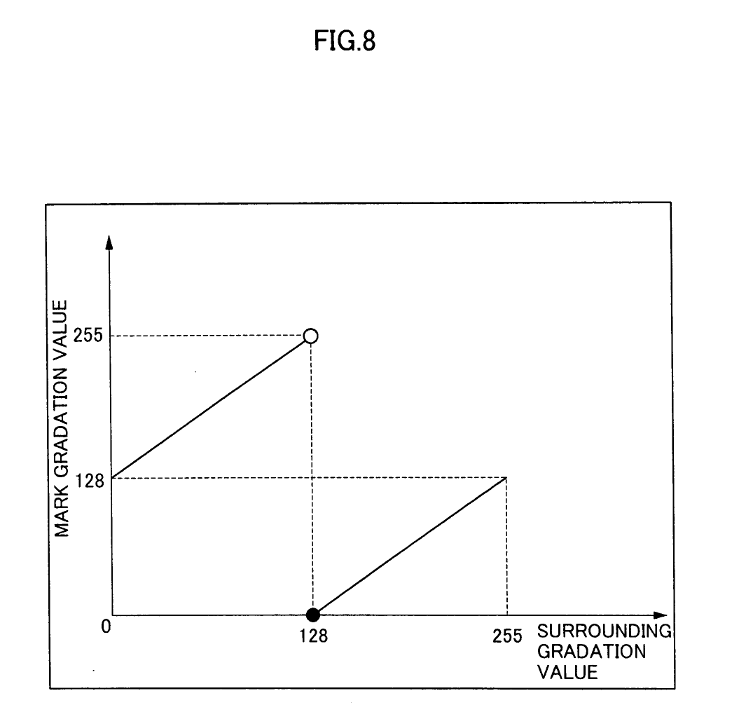

The gradation value for the mark dots deviates from an average value for the mark dot gradation value reference dots by 128 gradations. Then, the relationship between the gradation value for the mark dots and the average value for the surrounding mark gradation value reference dots is as shown in FIG. 8. For example, if the surrounding mark gradation value reference dots have an average value of 255, the mark dots have a gradation value of 128. With the printing method using the above described TA printers, to allow a dot to have the above gradation value, a dot is first generated for each of the three colors, Y, M, and C. Then, the three colors are superimposed on one another to create a dot of the desired color.

The deviation by 128 gradations causes the mark dots to have an unnoticeable color but can still be distinguished from the surrounding colors to allow the user to discover them easily when examining the print consciously.

The use of the above mark dots enables the user to discover the mark that is unnoticeable on the print when examining the print consciously.

According to the present embodiment, the mark dots are provided on a print. Thus, if any of the prints discharged to the output port 150 is defective (for example, it has excessively dark or light colors or is striped), the printer having produced this print can be determined from the position of the mark dots provided on the print. Accordingly, the cause of the defect can be determined promptly and accurately.

Furthermore, the user cannot find the mark dots without examining the print consciously. This prevents the quality of prints themselves from being degraded.

In the present embodiment, the mark dots are displayed on prints to identify the printers having produced these prints. However, the present invention is not limited to this aspect. Unnoticeable characters or patterns may be used with the analysis of the surrounding gradation values.

Moreover, in the present embodiment, the mark dots are provided on the same surface as that on which images are printed. This enables the application of a typical printing structure, thus eliminating the need for complicated facilities. Therefore, an inexpensive print system can be provided.

The printers in the print machine may be sublimation type thermal transfer printers or ink jet type printers.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A print system comprising:
a plurality of printers each having information identifying the printer,
a host section that transmits print data to the plurality of printers to instruct the printers to carry out printing,
a discharge portion to which prints from each printer are discharged,
a printer particular information providing device with which during printing, the printer provides, on each print to be discharged from the discharge portion, particular information indicating which printer has produced the print.

2. The print system according to claim 1, wherein each of the printers determines a position at which the particular information is to be provided, from the size of the print data transmitted to the printer.

3. The print system according to claim 2, wherein the particular information is a printed indication on printed surface of the print, and the printer analyzes print data present around the determined particular information provided position and applies, on the basis of results of the analysis, an indication which is less noticeable than the print data present around the determined particular information provided position but which can still be visually discovered.

4. The print system according to claim 2, wherein the position at which the particular information is provided varies with the printers, and each of the printers determines a position at which the particular information is to be provided on the basis of the information identifying the printer.

5. The print system according to claim 3, wherein the particular information is a printed indication on end portion of the printed surface of the print.

6. The print system according to claim 5, wherein said indication comprises dots and said print data present around comprises data of dots present around which are printed around the dots.

7. The print system according to claim 6, wherein a gradation value for the dots is value deviating from an average value for the dot gradation value of the dots present around by about 128 gradations.

8. A printer comprising:
an analyzing device analyzing print data, and
an indication providing device which provides an indication which is unnoticeable but can still be visually discovered, on a print to be produced, on the basis of results of the analysis.
